(19) United States
(12) Patent Application Publication
(10) Pub. No.: US 2026/0351970 A1
(43) Pub. Date: Nov. 5, 2026

(54) SYSTEMS AND METHODS FOR OPERATION OF ELECTRICAL INVERTERS

(71) Applicant: Siemens Corporation, Washington, DC (US)

(72) Inventors: Nareshkumar Nandola, Princeton, NJ (US); Aravind Ingalalli, Princeton, NJ (US); Jonathan Robinson, Munich (DE)

(73) Assignee: Siemens Corporation, Washington, DC (US)

(21) Appl. No.: 19/109,157

(22) PCT Filed: Aug. 1, 2023
(86) PCT No.: PCT/US2023/029163

§ 371 Date: Mar. 7, 2025

Related U.S. Application Data
(60) Provisional application No. 63/375,713, filed on Sep. 15, 2022.

(51) Int. Cl. H02J 3/00; H02J 3/1835; H02J 101/24; H02J 103/35; H02J 103/50

(52) U.S. Cl. CPC H02J 3/004; H02J 3/1835; H02J 2101/25; H02J 2103/35; H02J 2103/50

(57) ABSTRACT

Methods for controlling an inverter performed by an inverter control system and related systems and media. A method (300) includes receiving (302) a forecasted active power (102) and a reactive power profile (122) for an inverter (195), and determining (304), based on the forecasted active power (102) and the reactive power profile (122), a power loss prediction (106) over time for the inverter (195). The method includes determining (302) a temperature prediction (110) over time for the inverter (195) and performing (308) a rainflow analysis process (112) to produce temperature fatigue cycle data (114) for the inverter (195). The method includes determining (310) a damage prediction (118) over time for the inverter (195) and determining (312) a reactive power profile (122) over time for the inverter (195). The inverter (195) can thereafter be controlled (314) to produce power according to the reactive power profile (122).

### CROSS-REFERENCE TO OTHER APPLICATION

This application claims the benefit of the filing date of U.S. Provisional Patent Application 63/375,713, filed Sep. 15, 2022, which is hereby incorporated by reference.

### TECHNICAL FIELD

The present disclosure is directed, in general, to systems and methods for the operation of grid-connected electrical inverters.

### BACKGROUND OF THE DISCLOSURE

Electrical power generation and grid infrastructures are rapidly expanding from traditional carbon-based power-generation sources to renewable sources that rely on electrical inverters. Inverter-based resources are a growing segment of the electrical grid, enabling reliable, clean-energy power generation. In practice, grid-connected inverters are operated as necessary to meet power demand from the load side, without considering the impact of such an operation on the inverter life cycle. As a result, the lifecycle of a given inverter may be shortened significantly simply based on its usage, resulting in significant maintenance and replacement costs of the resource. Improved systems and methods for the operation of these electrical inverters are desirable.

### SUMMARY OF THE DISCLOSURE

Various disclosed embodiments include methods for controlling an inverter performed by an inverter control system and related systems and media. In particular, disclosed embodiments relate to grid-connected inverters, including photovoltaic inverters.

Disclosed embodiments include a method for controlling an inverter performed by an inverter control system. The method includes receiving a forecasted active power and an optimal reactive power profile for an inverter. The reactive power profile can be received as a feedback from optimizer to an inverter. The method includes determining, based on the forecasted active power and the optimal reactive power profile, a power loss prediction over time for the inverter. The method includes determining, based on the power loss prediction and an ambient temperature, a temperature prediction over time for the inverter. The method includes performing, based on the temperature prediction over time, a rainflow analysis process to produce temperature fatigue cycle data for the inverter. The method includes determining, based on the temperature fatigue cycle data, a damage prediction over time for the inverter. The method includes determining, based on the damage prediction and the power loss prediction, an optimal reactive power profile over time for the inverter. The inverter can thereafter be controlled to produce power according to the reactive power profile. This process can also be repeated at fixed time interval or periodically to accommodate any change in active power forecast and any mismatch between forecasted active power and actual active power produced and obtain most updated optimal reactive power profile.

In various embodiments, the inverter is controlled by the inverter control system or by an inverter controller that receives the reactive power profile from the inverter control system. In various embodiments, determining the power loss prediction, determining the temperature prediction, the rainflow analysis process, and/or determining the damage prediction is performed using a nonlinear model in the inverter control system. In various embodiments, determining the reactive power profile is performed using constrained optimization process in the inverter control system. In various embodiments, the reactive power profile is used as the power control profile for a subsequent iteration of the method.

Other embodiments include an inverter control system comprising a processor and an accessible memory, configured to perform processes as described herein. Other embodiments include a non-transitory computer-readable medium encoded with executable instructions that, when executed, cause one or more inverter control systems to perform processes as described herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a control system in accordance with disclosed embodiments in which an embodiment can be implemented;

FIG. 2 illustrates an example of an inverter control system and process in accordance with disclosed embodiments;

FIG. 3 illustrates a flowchart of a process in accordance with disclosed embodiments.

### DETAILED DESCRIPTION

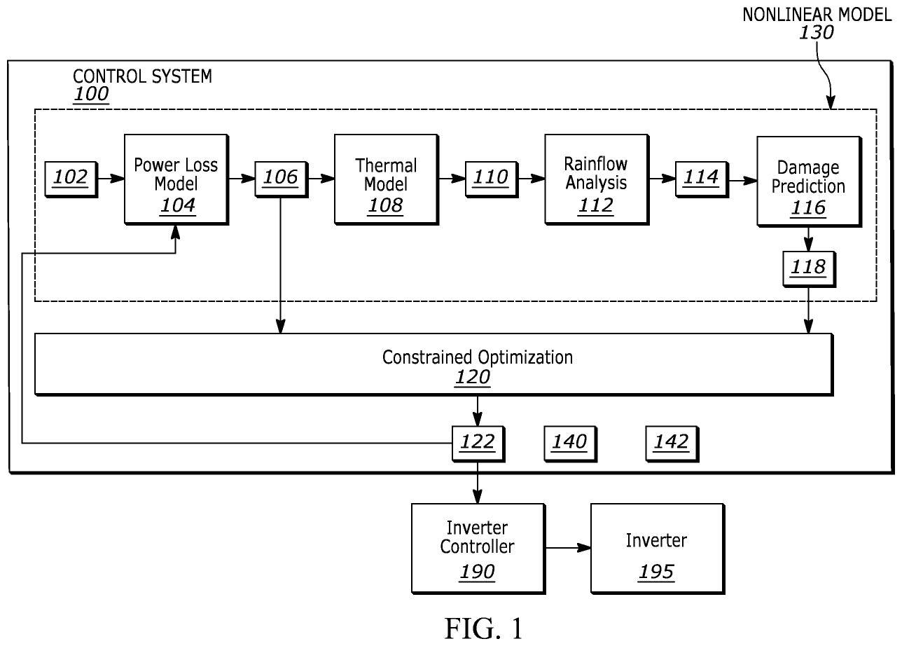

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include systems and methods that optimize overall inverter life by exploiting available room in acceptable inverter efficiency, such as an acceptable threshold on loss.

Inverters are designed for a rated capacity assuming nominal operating conditions. However, in practice, operating conditions of inverters are stochastic and diverse in nature with respect to hot to cold regions. For these reasons and others, a given inverter may not achieve its desired life span. While some systems may take simple actions such as curtailing active power or feeding reactive power to the grid based on some event-based heuristics, there is no systematic processes that consider the trade-off between efficiency, such as power loss, and overall inverter life. Disclosed embodiments include systems and methods that intelligently balance short term loss in, for example, efficiency, with long term loss, such as damage to or decreased lifespan of the inverter.

Ideally, every inverter would be custom-designed for its specific operating environment, but this ideal is not practical. Because of this, the reliability of such inverters is affected by temperature fatigue cycles due to change in power demand. In some cases, grid-connected inverters can inject the reactive power to support the grid voltage and to minimize temperature fatigue at the expense of its efficiency. Thus, there is a trade-off between the inverter efficiency and the damage to an inventor or a reduction in its lifespan. Disclosed embodiments include model-based operation of inverters that addresses this issue to enhance the overall lifecycle of inverter while achieving at least minimum acceptable inverter efficiency to avoid power loss below a defined threshold.

In this way, the disclosed systems and methods produce the distinct technical advantage of extending the useful life of electrical inverters in a power grid system without falling below power-generation requirements. While specific examples are described below in terms of photovoltaic (PV) inverter, those of skill in the art will recognize that the systems and methods described herein apply to any electrical inverter system, and in particular to grid-connected inverters.

FIG. 1 illustrates an inverter control system 100 in accordance with disclosed embodiments, together with inverter controller 190 and an inverter 195. Note that, in some embodiments, the functions of inverter controller 190 can be performed by control system 100 so that a separate inverter controller 190 is not necessary. Further note that control system 100 can be implemented in any general-purpose or special purpose computer system, or combination of computer systems, configured to perform the processes described herein, and includes processors and/or controllers 140, memory and other storage 142 (which includes non-transitory computer-readable media), and other components necessary or useful in such a computer system.

This example of control system 100 uses forecasted active power

$${P}_{MPP}^{est}$$

102 as an input to a nonlinear model 130. Long term forecast of active power

$${P}_{MPP}^{est}$$

can be made by considering multiple parameters such as historic future energy demand, weather conditions, etc. As illustrated in FIG. 1, forecasted power

$${P}_{MPP}^{est}$$

is used to predict future losses and damages using nonlinear model 130.

As illustrated in FIG. 1, nonlinear model 130 is a combination of power loss model 104, thermal model 108, rainflow analysis 112, and damage prediction 116. This figure illustrates how these different submodels are linked and combined together, in this example of a control system 100 and related process, to derive a nonlinear model, which can predict power loss and damage (or remaining life). Nonlinear model 130 can be regarded as a time-domain representation of the nonlinear model, and can be discretized based on the sampling rate of the forecasted power.

While the processes illustrated in FIG. 1 are described in more detail below, this example shows that power loss model 104 of nonlinear model 130 (of control system 100) receives forecasted active power

$${P}_{MPP}^{est}$$

102 as an input and using a reactive power Q as an input. Reactive power Q may be represented as a waveform or other projection over time, as Q*(t), representing the optimal reactive power profile 122 obtained from the constrained optimization process 120 below. Forecasted active power

$${P}_{MPP}^{est}$$

102 can be in the form of a waveform or other projection over time. Power loss model 104 produces a future power loss prediction and damages as a function of reactive power (Q). This prediction is illustrated as power loss prediction 106 over a horizon. Alternately, the power loss prediction can be represented as

$${P}_{Total}^{loss} = {y}_{1} ( t ) = f ( {I}_{p} , {Q}^{*} ) .$$

In this example, y₁ represents total inverter power loss and y₂ (below) represents inverter damage.

Power loss prediction 106 is then processed by a thermal model 108 along with an ambient temperature T_{amb} to produce a temperature prediction 110 over a horizon. Thermal model 108 can be a thermal fatigue-cycle estimation model as described herein.

Temperature prediction 110 is processed by a rainflow analysis process 112 to produce temperature fatigue cycle data 114, which can include temperature fatigue cycle data, for example, average temperature T_{avg} and change in temperature ΔT.

Temperature fatigue cycle data 114 is then processed by a damage prediction process 116 to produce damage prediction 118 over a horizon.

Constrained optimization process 120 receives the damage prediction 118 and applies any current constraints, including power factor constraints or others, to produce a reactive power control profile Q*(t) 122. Reactive power control profile 122 can be in the form of a waveform over time. Reactive power control profile 122 can also be delivered to power loss model 104 to be used in subsequent iterations in conjunction with the forecasted active power

$${P}_{MPP}^{est}$$

102. Constrained optimization process 120 also uses power loss prediction 106 to produce the reactive power control profile Q*(t) 122.

Inverter control 190 receives the reactive power control profile 122 and uses it to control inverter 195. In this process, the reference reactive power Q_{ref} can be established at time t=1 for the reactive power control profile 112. The first value of active power Q*(1) at time t=1 can be given to the lower-level inverter control as a setpoint Q_{ref}. That is, Q_{ref}=Q*(1).

The processes described above can be used in a receding horizon optimization framework as described herein, and can be used for power loss and damage prediction. Note that the power loss model 104 and the thermal model 108 can be physics-based or data-based models. The rainflow analysis 112 can be implemented using a rainfall algorithm, known to those of skill in the art, that produces a cycle count in a given profile. In this case, rainflow analysis 112 can use this algorithm to produce a temperature profile.

The damage prediction process 116 can be based on the empirical relations that takes output of rainflow analysis 112 and estimates remaining useful life of the inverter (or damages to the inverter) as damage prediction 118. Damage prediction 118 can be represented, for example, as y₂(t)=f(T_{avg}, ΔT).

In various embodiments using the system and process illustrated in FIG. 1, at a time, t, the prediction of losses and damages are made over a shorter horizon, which are then used for optimize trade-off between losses and damages and calculates the optimal reactive power control profile Q*(t) 122 over a horizon. From this optimal reactive power profile 122, as described above, first value of active power Q*(1) at time t=1 can be given to the lower-level inverter control as a setpoint Q_{ref}.

At each sample time, this optimization is repeated in a receding horizon fashion, meaning a new profile for reactive power Q is calculated by moving the horizon window by one sampling time and considering active power forecasts for the new window. In this way, the control system 100 uses repetitive optimization to accommodate any unmeasured disturbances or any change in active power demand as well as any uncertainty or mismatch between the model and actual behavior, via the feedback mechanism provided by using both reactive power profile 122 and forecasted active power Pₑₛₜ 102 by power loss model 104.

A PV inverter interfaces the direct-current (DC) side of the PV plant to the alternating-current (AC) power grid, facilitating the power conversion application. PV inverters are required to achieve low failure rates during the PV system service life of 20 or more years. Design for reliability is one of the approaches to enhance PV inverter reliability by appropriate component design in the early stage of the product development. The component design and selection require a priori knowledge of the PV load profiles under various operating conditions, characterized by the ambient temperature and irradiance. Such load profiles can be used to estimate the lifetime of the power components of the PV inverter.

Disclosed embodiments can use nonlinear model-based constrained optimization processes to produces a real-time optimal reactive power setpoint for the lower-level inverter control while optimizing a trade-off between inverter power losses and the inverter damage. The nonlinear relationship between the reactive power, inverter power losses and the damage are obtained by combining the power loss model, an empirical thermal fatigue cycle model (the thermal model), and an empirical model for life cycle estimation (the damage prediction process).

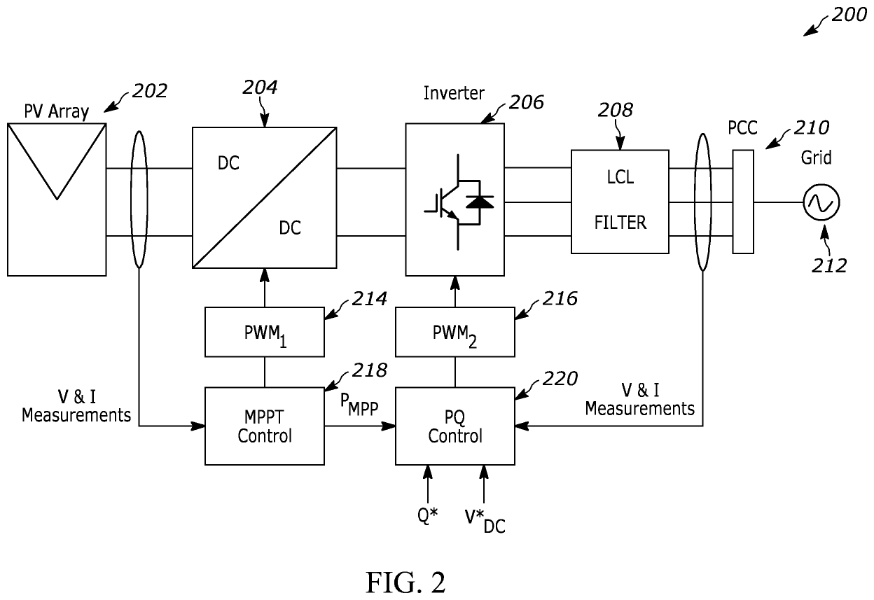

FIG. 2 illustrates an example of an inverter control system and process in accordance with disclosed embodiments. As described herein, such a control system, using disclosed processes, can achieve maximum power point (MPP) power delivery to AC grid, and is capable of injecting reactive power as per the given set-point (Q*).

As shown in FIG. 2, a PV inverter control system 200 includes PV array 202 and a double-stage converter: DC-DC stage 204 and DC-AC (inverter) stage 206, which is connected to point of common coupling (PCC) 210 and the grid 212 via an inductor-capacitor-inductor (LCL) filter 208. The inductor-capacitor-inductor (LCL) filter 208 with damping resistor is used to reduce the current harmonics.

The PV inverter control system 200 can be operated to produce maximum power from the PV array 202 by controlling DC-DC stage using maximum power point tracking (MPPT) control 218 and pulse width modulator (PWM₁) 214, based at least in part on voltage and current measurements from PV array 202. While, on the AC side, the PQ inverter controller 220 and pulse width modulator (PWM₂) 216 is used to control the DC link voltage and reactive power at its predefined setpoints, V*_{DC} and Q*, respectively. Moreover, as shown in the figure, the PQ controller 220 takes the power generated by the PV array 202 as determined by MPPT control 218 (i.e., P_{MPP}) as a feedforward input and uses the voltage and the current measured at the PCC 210 as the feedback. Thus, the inverter control enables the injection MPP active power (i.e., P_{MPP}) and reactive power as per the given set-points. PV systems can be designed with reasonable capacity margins and operate under partial loading conditions. Therefore, inverters can be utilized to inject reactive power as determined using the techniques disclosed herein, especially during nights with possible higher reactive power injection.

During the normal operating mode of the PV system and the grid system, the maximum reactive power supply, Qₘₐₓ, is subject to the reactive power constraint, which is represented as a function of the inverter nominal apparent power, Sₙₒₘ, and the active power delivered at MPPT (P_{MPP}) as follows:

Qₘₐₓ=\sqrt{(Sₙₒₘ²−P_{MPP}²)} (1)

Disclosed embodiments can employ a nonlinear model for power loss and estimation of the lifetime of the inverters, such as PV inverters. Various embodiments include a unified nonlinear model that relates active and reactive power with inverter power loss and the damage. For the power loss estimation of the PQ control-based inverter, an electro-thermal modeling can be used, and inverter damage can be estimated using thermal fatigue-cycle.

As described with respect to FIG. 1, power loss model 104 can be used to produce a future power loss prediction and damages as a function of reactive power (Q). This prediction is illustrated as power loss prediction 106 over a horizon. The following described a non-limiting, exemplary implementation of such a power loss prediction model as disclosed herein.

Inverter losses can be contributed by a power module including an insulated-gate bipolar transistor (IGBT) and a diode. The losses in the power module are mainly classified as conduction and switching losses. Conduction loss includes on-state IGBT and on-state diode losses. The switching loss includes the on/off losses and reverse recovery losses. Hence the total losses per cycle are given as,

$${P}_{Total}^{loss} = {P}_{IGBT}^{loss} + {P}_{Diode}^{loss} \qquad ( 2 )$$

$${P}_{IGBT}^{loss} = {P}_{IGBT}^{Con} + {P}_{IGBT}^{SW} \qquad ( 3 )$$

$${P}_{Diode}^{loss} = {P}_{Diode}^{Con} + {P}_{Diode}^{SW} \qquad ( 4 )$$

$${P}_{IGBT}^{Con} = ( \frac{1}{8} - \frac{m cos φ}{3 pi} ) RCE {I}_{p}^{2} + ( \frac{1}{2} - \frac{m cos φ}{3 pi} ) {VT}_{0} {I}_{p} \qquad ( 5 )$$

$${P}_{IGBT}^{SW} = 0.5 {F}_{sw} \frac{{V}_{D C}}{{V}_{CC}} ( {A}_{IGBT} \frac{{I}_{p}^{2}}{2} + {B}_{IGBT} \frac{2 {I}_{p}}{pi} + {C}_{IGBT} ) \qquad ( 6 )$$

$${P}_{Diode}^{Con} = ( \frac{1}{8} + \frac{m cos φ}{3 pi} ) RDF {I}_{p}^{2} + ( \frac{1}{2} + \frac{m cos φ}{3 pi} ) {VF}_{0} {I}_{p} \qquad ( 7 )$$

$${P}_{Diode}^{SW} = 0.5 {F}_{sw} \frac{{V}_{D C}}{{V}_{CC}} ( {A}_{Diode} \frac{{I}_{p}^{2}}{2} + {B}_{Diode} \frac{2 {I}_{p}}{pi} + {C}_{Diode} ) \qquad ( 8 )$$

where Iₚ is the peak AC current

$$m = \frac{2 \sqrt{2} {V}_{L - L}}{\sqrt{3} {V}_{D C}}$$

is modulation index, F_{sw} is the switching frequency, cosφ is the power factor, V_{L-L} line AC voltage, V_{DC} is DC link voltage, and the rest of the variables in of (5)-(7) are module related parameters that obtained from the manufacturer datasheet of the respective components. Further, it is noted that the peak AC current varies with P_{MPP} while power factor varies with P_{MPP} and reactive power Q. Thus, total inverter power loss can be represented as a function of Iₚ and Q. Here,

$${P}_{MPP}^{est}$$

is the same as P_{MPP}, is a function of Iₚ, and can be used as an input to power loss model 104 to produce the power loss prediction 106.

Referring again to FIG. 1, a thermal model 108, such as a thermal fatigue-cycle estimation model, uses power loss prediction 106 to produce a temperature prediction 110 over a horizon. The thermal design aspects of components can be critical for the reliable operation of IGBT modules. The thermal characteristics of the IGBT module for a given loading scenario can be modeled using the Cauer and Foster models, familiar to those of skill in the art. The Cauer model represents the physical transient thermal behavior and requires the suitable material property knowledge of the module. On the other hand, the Foster model is an empirical model derived using data. Since most of the manufacturer datasheets provide the parameters for the analytical function of thermal impedance, the Foster model as given below in (9)-(11), is used to illustrate one exemplary implementation of thermal modeling:

$${T}_{h} = {P}_{Total}^{loss} ( {R}_{h} ( 1 - {e}^{- t / {τ}_{h}} ) ) + {T}_{amb} \qquad ( 9 )$$

$${T}_{IGBT} = {P}_{IGBT}^{loss} ( {\sum }_{i = 1}^{4} {RT}_{i} ( 1 - {e}^{- t / τ {t}_{i}} ) ) + {T}_{h} \qquad ( 10 )$$

$${T}_{Diode} = {P}_{Diode}^{loss} ( {\sum }_{i = 1}^{4} {RD}_{i} ( 1 - {e}^{- t / τ {d}_{i}} ) ) + {T}_{h} \qquad ( 11 )$$

where Tₕ is the temperature of the heatsink, T_{amb} is the ambient temperature. The junction temperature, Tⱼ=max (T_{IGBT}, T_{Diode}), is obtained by iteratively solving (2)-(8) and (9)-(11) with sampling frequency such as 50 Hz. The junction temperature profile represents the thermal fatigue cycles of the power module. Thus, it is further used to estimate inverter damage, as disclosed herein.

Nonlinear model 130 also determines accumulated damage and a life-time estimation of the inverter using rainflow analysis process 112 and damage prediction process 116.

For the power module, one common reason for failure is due to the thermal fatigue occurring from the temperature variations. For the damage calculation, among different thermo-mechanical mechanisms, solder fatigue and bond wire failure are two critical failure modes (both can occur at same time) caused by the mismatch of the coefficient of temperature expansion. Empirical model and physics of failure-based model are the two main type of models for the damage computation. Empirical models are the analytical models built on the field data are relatively less complex to compute in comparison to physics of failure models. Various disclosed embodiments use a Coffin-Manson model, familiar to those of skill in the art, is for the damage computation as it provides an empirical representation of dependency on both mean temperature and the temperature ranges on the overall damage. According to this model, the number of cycles to failure (N_{f}) is given by:

$${N}_{f} = {A ( Δ {T}_{j} )}^{α} exp ( \frac{{E}_{α}}{{k}_{b} ( {T}_{jm} + 273 )} ) \qquad ( 12 )$$

where A, α, Eₐ, and k_{b} are model parameters as given in TABLE I, below, while ΔTⱼ and Tⱼₘ are the temperature range and the mean temperature of the j^{th} thermal cycle of junction temperature (Tⱼ) profile (and is also represented more simply as T_{avg}. The junction temperature is obtained using thermal model discussed earlier. In particular, rainflow analysis process 112 can implement a rainflow counting algorithm to obtain ΔTⱼ and Tⱼₘ from the junction temperature profile. Rainflow counting is known to those of skill in the art and can be used to calculate the fatigue life of a component including power modules of the inverter. For example, the MATLAB function rainflow.m, which provides data as per the ASTM-E 1049 standard, can be used.

To estimate lifetime of the inverter, damage prediction process 116 can computer the cumulative damage at each sample of a forecasted PV power generation profile as follows, based on the Miner's rule, familiar to those of skill in the art:

$$AD ( k ) = AD ( k - 1 ) + {\sum }_{j = 1}^{N} \frac{{N}_{j}}{{N}_{f} ( j )} \qquad ( 13 )$$

where AD is the accumulated damage over a time with the unit year⁻¹, N is the number of thermal cycles in the k^{th} sample thermal profile, N_{f}(j) is the number of cycles to failure, and Nⱼ is the half or full cycle value during the j^{th} thermal cycle obtained from the rainflow-counting algorithm. The significance of estimated AD reaching 100% is that at least one of the power components in the PV inverter is prone to damage. The lifetime of the inverter is estimated as the time to failure (TTF) in terms of years which is defined as

$$\frac{1}{AD} .$$

TABLE I
provides exemplary model parameters of an IGBT module
that can be used by the damage prediction process 116:

| Parameters | Value | Operating Condition |
|---|---|---|
| A | 3.3125 × 10⁶ | |
| α | 5.039 | 10 °C ≤ ΔTⱼ ≤ 100 °C |
| Eₐ | 9.89 × 10⁻²⁰ | 20 °C ≤ Tⱼ ≤ 120 °C |
| k_{b} | 1.38066 × 10⁻²³ | |

Disclosed embodiments can perform real-time nonlinear optimization of inverter's life and efficiency. As disclosed herein, an inverter system along with its primary control can be analyzed, including in the form of models, to estimate incurred losses and the damages of the critical component. The tradeoff between the component losses and the damage is analyzed as a nonlinear constrained optimization problem. The details of the same are described in this section. Disclosed techniques for analyzing and controlling the inverter operation provides the technical advantage of reducing the temperature ranges such that the lifetime of the PV inverter can be improved while maintaining the inverter efficiency above acceptable values.

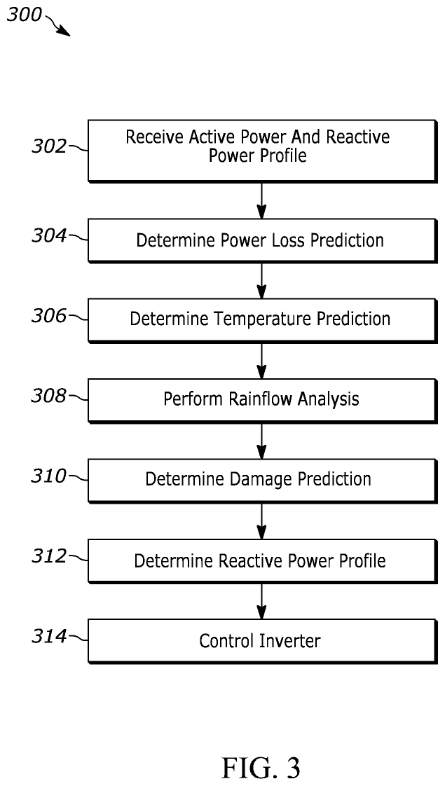

FIG. 3 illustrates a process for inverter control in accordance with disclosed embodiments, described in the context of FIG. 1. This process is performed by an inverter control system 100 as described herein, including a nonlinear model 130, which is referred to simply as the “system” below. This process uses an overall nonlinear model that can estimate inverter damage and power loss simultaneously as a function of a given inverter power

$$( {P}_{MPP}^{est} )$$

and reactive power setpoint (Q*) for PQ-based inverter control, and then control the inverter accordingly.

The system receives a forecasted active power and a reactive power profile (302). The forecasted active power can be a waveform or other projection over time, and the reactive power profile can represent required reactive power over time.

The system determines, based on the forecasted active power and the reactive power profile, a power loss prediction over time (304). This process can be performed by a power loss model of the nonlinear model.

The system determines, based on the power loss prediction and an ambient temperature, a temperature prediction over time (306). This process can be performed by a thermal model of the nonlinear model and can be performed by using a thermal fatigue-cycle estimation model.

The system performs, based on the temperature prediction over time, a rainflow analysis process (308) to produce temperature fatigue cycle data. The temperature fatigue cycle data can include an average temperature T_{avg} over time and change in temperature ΔT over time for the inverter.

The system determines, based on the temperature fatigue cycle data, a damage prediction over time for the inverter (310). This can be performed by a damage prediction process of the nonlinear model.

The system determines, based on the damage prediction, a reactive power profile over time for the inverter (312). The reactive power profile can be returned to 302 in subsequent iterations. The first value of reactive power profile (Q*(1) at time t=1) can use and be used as a setpoint Q_{ref}.

The inverter is controlled to produce power according to the reactive power profile (314). This can be performed by passing the reactive power profile over time to an inverter controller to control the inverter or can be performed by the system controlling the inverter directly.

According to this process, the nonlinear model takes known (forecasted) power at each time sample, t, and ambient temperature as inputs and estimates

$$y ( t ) := {[ {P}_{Total}^{loss} ( t ) AD ( t ) ]}^{T} ,$$

i.e., inverter power loss and accumulated damage.

The losses in the power module can depend on the peak current and the impedance angle which in turn can depend on the active and reactive power supplied by the inverter. Moreover, by manipulating the injection of reactive power, temperature ranges and the mean temperatures can be reduced, hence improving the lifetime. As the inverter active power supply cannot be compromised, the systems and methods described herein determine a required reactive power reference (Q*). Disclosed techniques use the nonlinear model represented in FIG. 1 to predict the inverter damage and power loss over a finite future horizon, H, considering known inverter power forecast

$$( {P}_{MPP}^{est} )$$

over the Horizon, and determines the optimal future reactive power as follows:

$${min}_{{Q}^{*} ( k ) , … , {Q}^{*} ( k + H - 1 )} J = {\sum }_{i = 1}^{H} {y ( k + i )}^{T} w y ( k + i ) \qquad ( 14 )$$

subjected to (2)-(13), ∀ i

$${{Q}^{*} ( k + i )}^{2} + {{P}_{MPP}^{est} ( k + i )}^{2} - {S}_{nom}^{2} \leq 0 \qquad ( 15 )$$

$${Q}_{LB} \leq {Q}^{*} ( k + i ) \leq {Q}_{UB} , i = 0 , … , H - 1 \qquad ( 16 )$$

where,

$$w = [ \begin{matrix}{w}_{1} & 0 \\ 0 & {w}_{2}\end{matrix} ]$$

is a 2×2 weighing matrix for the power loss and the damage. The nonlinear model is captured by the constraints (2)-(13). The limitation on reactive power injection capability due to the uncompromised supply of active power for a given rating of the inverter is given by (15). Device limitation to supply the reactive power is represented as a constraint in (16).

Using (14)-(16) and the series of processes described herein, the system gives H future optimal values for the reactive power Q*. The first value from these H future values of Q* can be implemented as setpoint of lower-level PQ-controller at each sample interval. At each sampling interval, the process iterates according to the updated power forecast (shifted in time by one sample) and updated ambient temperature. Thus, the system performs optimization in real-time to accommodate any changes in the power forecast and any in the ambient temperature, and controls the inverter accordingly. It is assumed that the grid can absorb the injected maximum reactive power (Q_{UB}) without causing the grid voltage range violations.

There is always a trade-off between the inverter life-time improvement, and its efficiency that is rightly captured quantitatively in (14)-(16). To adjust performance of the disclosed real-time optimization, the weights w₁ and w₂ can be varied systematically to meet the desired objective and to meet their reliability requirements. The upper bound (Q_{UB}) for the reactive power injection can be fixed depending on the device capability.

The following references are incorporated by reference:
M. Tahir Patel, Ramachandran A. Vijayan, Reza Asadpour, M. Varadharajaperumal, M. Ryyan Khan, Muhammad A. Alam, Temperature-dependent energy gain of bifacial PV farms: A global perspective, Applied Energy, Volume 276, 2020.
A. Sangwongwanich, Y. Yang, D. Sera, F. Blaabjerg and D. Zhou, “On the Impacts of PV Array Sizing on the Inverter Reliability and Lifetime,” in IEEE Transactions on Industry Applications, vol. 54, no. 4, pp. 3656-3667 July-August 2018, doi: 10.1109/TIA.2018.2825955.
A. Golnas, “PV System Reliability: An Operator's Perspective,” in IEEE Journal of Photovoltaics, vol. 3, no. 1, pp. 416-421, January 2013, doi: 10.1109/JPHOTOV.2012.2215015.
Y. Yang, A. Sangwongwanich and F. Blaabjerg, “Design for reliability of power electronics for grid-connected photovoltaic systems,” in CPSS Transactions on Power Electronics and Applications, vol. 1, no. 1, pp. 92-103, December 2016, doi: 10.24295/CPSSTPEA.2016.00009.
S. Bouguerra, M. R. Yaiche, O. Gassab, A. Sangwongwanich and F. Blaabjerg, “The Impact of PV Panel Positioning and Degradation on the PV Inverter Lifetime and Reliability,” in IEEE Journal of Emerging and Selected Topics in Power Electronics, vol. 9, no. 3, pp. 3114-3126 Jun. 2021, doi: 10.1109/JESTPE.2020.3006267.
A. Sangwongwanich, Y. Yang, D. Sera and F. Blaabjerg, “Mission Profile-Oriented Control for Reliability and Lifetime of Photovoltaic Inverters,” in IEEE Transactions on Industry Applications, vol. 56, no. 1, pp. 601-610, January-February 2020, doi: 10.1109/TIA.2019.2947227.
Y. Wang, D. Liu, P. Liu, F. Deng, D. Zhou and Z. Chen, “Lifetime-Oriented Droop Control Strategy for AC Islanded Microgrids,” in IEEE Transactions on Industry Applications, vol. 55, no. 3, pp. 3252-3263 May-June 2019, doi: 10.1109/TIA.2019.2898847.
Y. Chen, L. Wang, S. Liu and G. Wang, “A Health-oriented Control Strategy for DC-Link Capacitor in Direct Drive Wind Turbine Converter,” in IEEE Transactions on Power Delivery, doi: 10.1109/TPWRD.2022.3148112.
X. Su, M. A. S. Masoum and P. J. Wolfs, “Optimal PV Inverter Reactive Power Control and Real Power Curtailment to Improve Performance of Unbalanced Four-Wire LV Distribution Networks,” in IEEE Transactions on Sustainable Energy, vol. 5, no. 3, pp. 967-977, July 2014, doi: 10.1109/TSTE.2014.2313862.
O. Gandhi, C. D. Rodríguez-Gallegos, N. B. Y. Gorla, M. Bieri, T. Reindl and D. Srinivasan, “Reactive Power Cost From PV Inverters Considering Inverter Lifetime Assessment,” in IEEE Transactions on Sustainable Energy, vol. 10, no. 2, pp. 738-747, April 2019, doi: 10.1109/TSTE.2018.2846544.
R. Peña-Alzola, M. Liserre, F. Blaabjerg, R. Sebastián, J. Dannehl and F. W. Fuchs, “Analysis of the Passive Damping Losses in LCL-Filter-Based Grid Converters,” in IEEE Transactions on Power Electronics, vol. 28, no. 6, pp. 2642-2646 Jun. 2013, doi: 10.1109/TPEL.2012.2222931.
Infineon Technical Documentation, “Dimensioning program IPOSIM for loss and thermal calculation of infineon IGBT modules.” pp. 1-21.
“Website of infineon, infineon IGBTmodule datasheet (FF1000R17IE4),” 2020. [Online]. Available at time of filing from www.infineon.com
ABB Application Note: 5SYA 2093-00, “Thermal design and temperature ratings of IGBT modules.” pp. 1-8.
A. Hanif, Y. Yu, D. DeVoto and F. Khan, “A Comprehensive Review Toward the State-of-the-Art in Failure and Lifetime Predictions of Power Electronic Devices,” in IEEE Transactions on Power Electronics, vol. 34, no. 5, pp. 4729-4746 May 2019, doi: 10.1109/TPEL.2018.2860587.
L. Nicola, “Lifetime estimation of IGBT power modules,” Master Dissertation, Dept. of Electrical Engineering, Aalborg University, Denmark, August 2013.
The MathWorks Inc. Available at time of filing from www.mathworks.com.
ASTM, “Standard practices for cycle counting in fatigue analysis,” West Conshohocken, PA, 1985. [Online]. Available at time of filing from cds.cern.ch/record/1463271
N. N. Nandola, N. S. Kaisare, A. Gupta, “Online optimization for a plunger lift process in shale gas wells”, Computers & Chemical Engineering 108, 89-97
NREL (2006). Solar Power Data for Integration Studies. [Online]. Available at time of filing from www.nrel.gov/grid/solar-power-data.html

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112 (f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112 (f).

1. A method for controlling an inverter performed by an inverter control system (100), comprising:
receiving a forecasted active power and a reactive power profile for an inverter;
determining, based on the forecasted active power and the reactive power profile, a power loss prediction over time for the inverter;
determining, based on the power loss prediction and an ambient temperature, a temperature prediction over time for the inverter;
performing, based on the temperature prediction over time, a rainflow analysis process to produce temperature fatigue cycle data for the inverter;
determining, based on the temperature fatigue cycle data, a damage prediction over time for the inverter; and
determining, based on the damage prediction and the power loss prediction, a reactive power profile over time for the inverter, wherein the inverter is thereafter controlled to produce power according to the reactive power profile.

2. The method of claim 1, wherein the inverter is controlled by the inverter control system.

3. The method of claim 1, wherein the inverter is controlled by an inverter controller that receives the reactive power profile from the inverter control system.

4. The method of claim 1, wherein determining the power loss prediction is performed using a nonlinear model in the inverter control system.

5. The method of claim 1, wherein determining the temperature prediction is performed using a nonlinear model in the inverter control system.

6. The method of claim 1, wherein the rainflow analysis process is performed using a nonlinear model in the inverter control system.

7. The method of claim 1, wherein determining the damage prediction is performed using a nonlinear model in the inverter control system.

8. The method of claim 1, wherein determining the reactive power profile is performed using constrained optimization process in the inverter control system.

9. The method of claim 1, wherein the reactive power profile is used as the reactive power profile for a subsequent iteration of the method.

10. An inverter control system comprising a processor and an accessible memory (142), the inverter control system (100) particularly configured to perform a method as claimed in claim 1.

11. A non-transitory computer-readable medium encoded with executable instructions that, when executed, cause one or more inverter control systems to perform a method as claimed in claim 1.
